(19) United States
(12) Patent Application Publication
(10) Pub. No.: US 2009/0136217 A1
(43) Pub. Date: May 28, 2009

(54) REPRODUCTION APPARATUS, REPRODUCTION SYSTEM, AND REPRODUCTION METHOD

(75) Inventors: Masashi Shin, Fussa-shi (JP); Takashi Hirahara, Ome-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, TOKYO (JP)

(21) Appl. No.: 12/269,119

(22) Filed: Nov. 12, 2008

(30) Foreign Application Priority Data
Nov. 28, 2007 (JP) 2007-307914

(51) Int. Cl. H04N 5/00

(52) U.S. Cl. 386/126; 386/E05.001

(57) ABSTRACT

According to one embodiment, a video reproduction section reproduces content using a reproduction module. A version upgrade management section reads a content ID of content recorded on an optical disc and determines whether or not update of the reproduction module is required based upon comparison between the content ID and a version upgrade list stored in a storage section. When update of the reproduction module is required, the version upgrade management section acquires another reproduction module from a server apparatus via a network and updates the reproduction module in the reproduction section using another reproduction module. The video reproduction section reproduces the content recorded on the optical disc using the updated reproduction module.

### CROSS-REFERENCE TO RELATED APPLICATIONS

This application is based upon and claims the benefit of priority from Japanese Patent Application No. 2007-307914, filed Nov. 28, 2007, the entire contents of which are incorporated herein by reference.

### BACKGROUND

1. Field

One embodiment of the present invention relates to a reproduction apparatus, a reproduction system, and a reproduction method where a portion of a reproduction module is updated.

2. Description of the Related Art

Recently, according to spread of optical discs, many techniques for improving reproduction quality of an optical disc have been known. As one of such techniques, a technique for updating firmware is known when a signal format of content data which an optical disc stores therein does not correspond to the firmware completely.

Jpn. Pat. Appln. KOKAI Publication No. 02004-185096 describes a technique for accessing a version upgrade site using a PC (personal computer) to conduct version upgrade of another AV (audio-video) device.

In the prior art such as shown in this publication, however, when a user reproduces an optical disc, the user must perform operations for access to, for example, a server, on the Internet to download a necessary module for reproduction if the user feels it necessary to do so. Accordingly, determination and/or operation made by a user are bothersome, which results in a burden on the user.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a block diagram showing one example of a configuration of a reproduction apparatus according to one embodiment of the present invention;

FIG. 2 is a block diagram showing one example of an operation of the reproduction apparatus according to one embodiment of the present invention;

FIG. 3 is a flowchart showing one example of a version upgrading operation of a reproduction module in the reproduction apparatus according to one embodiment of the present invention;

FIG. 4 is a flowchart showing one example of determining whether or not a version of the reproduction apparatus according to one embodiment of the present invention is required;

FIG. 5 is an illustrative diagram showing one example of a version upgrade list handled by the reproduction apparatus according to one embodiment of the present invention;

FIG. 6 is a flowchart showing one example of transmission processing of a content ID and reception processing of a version upgrade list and a version upgrade module in the reproduction apparatus according to one embodiment of the present invention;

FIG. 7 is a flowchart showing one example of transmission and reception processing of a content ID of a database server which conducts communication with the reproduction apparatus according to one embodiment of the present invention;

FIG. 8 is a flowchart showing one example of automatic reception processing of a version upgrade list of the reproduction apparatus according to one embodiment of the present invention;

FIG. 9 is a flowchart showing one example of automatic reception processing of a version upgrade list of the reproduction apparatus according to one embodiment of the present invention; and

FIG. 10 is a flowchart showing one example of automatic transmission processing of a version upgrade list of a database server which conducts communication with the reproduction apparatus according to one embodiment of the present invention.

### DETAILED DESCRIPTION

Various embodiments according to the invention will be described hereinafter. In general, according to one embodiment of the invention, there is a provided a reproduction apparatus comprising: an optical disc drive which reads identification information of content recorded on an optical disc; a communication section which conducts communication with an external apparatus via a network; a reproduction section which reproduces the content using a reproduction module; a determination section which determines whether or not update of the reproduction module in the reproduction section is required based upon comparison between the identification information and a version upgrade list for the content; an acquisition section which acquires another reproduction module from the external apparatus via the communication section when update of the reproduction module is required; and an update section which updates the reproduction module by another reproduction module acquired by the acquisition section. The reproduction section reproduces the content recorded on the optical disc using the reproduction module updated by the update section.

Therefore, by loading an optical disc simply, a reproduction module required for reproduction is automatically updated via a network, so that reproduction of the content can be performed securely.

An embodiment of the invention will be explained in detail below with reference to the drawings.

### One Example of Reproduction Apparatus and Database Server According to One Embodiment of the Invention

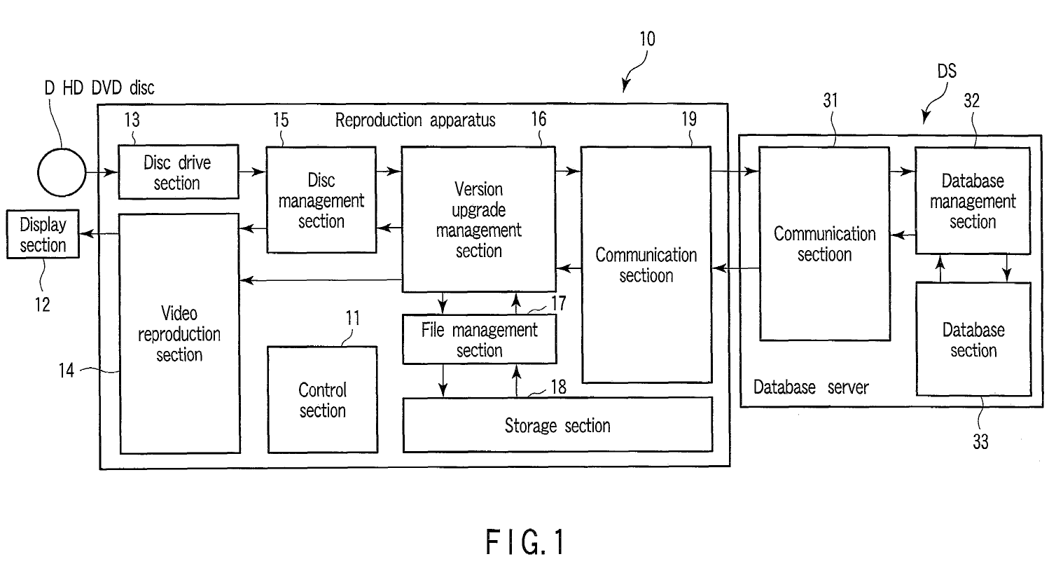

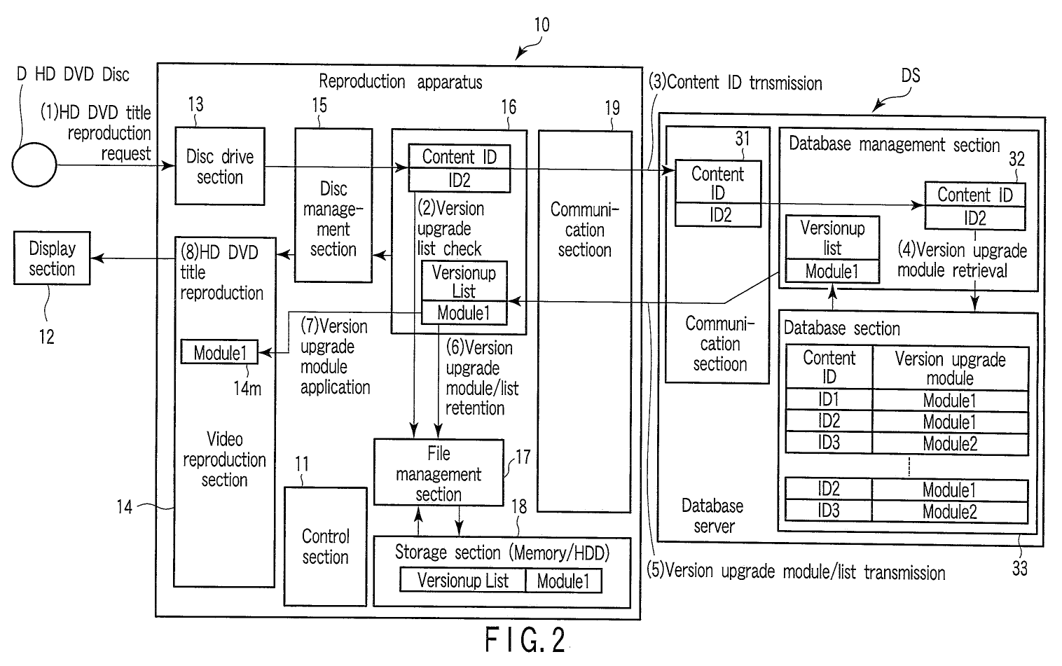

Next, one example of a reproduction apparatus and a database server according to one embodiment of the present invention will be explained with reference to the drawings. FIG. 1 is a block diagram showing one example of a configuration of a reproduction apparatus according to one embodiment of the present invention. FIG. 2 is a block diagram showing an operation example of the reproduction apparatus according to one embodiment of the present invention.

(Configuration)

A reproduction apparatus 10 and a database server DS according to one embodiment of the present invention are connected to each other via a network such as, for example, Internet, as shown in FIG. 1.

The reproduction apparatus 10 includes a control section 11 which conducts operations of the whole reproduction apparatus 10, a disc drive 13 in which an HD DVD disc D is loaded as one example, a disc management section 15 which manages an optical disc, a version upgrade management section 16 which manages version upgrade processing of a reproduction module for an optical disc, a video reproduction section 14 which includes a codec section and an ECMA script analyzing section, and a display section 12 on which video or operation information reproduced by the video reproduction section 14 is displayed. Further, the reproduction section 10 includes a file management section 17 which manages a file or a video file, a management file, and the like managed in the version upgrade management section 16, a storage section 18 which records content data, management information, and the like acquired from an optical disc, and a communication section 19 which has a communication function such as Internet.

The database server DS connected to the reproduction apparatus 10 via a network such as Internet includes a communication section 31 which conducts communication via a network, a database section 33 which stores at least a version upgrade list and reproduction module information for version upgrade therein, and a database management section 32 which manages behavior of the database section 33.

(Operation)

Basic Operation

The reproduction apparatus 10 with the abovementioned configuration includes a reproduction function of content in an optical disc and a reproduction function of content stored in the storage section 18 as a basic operation. That is, the disc drive 13 detects content from a loaded HD DVD disc D under control of the control section 11. The detected content is decoded and analyzed in the codec section and the ECMA script analyzing section in the video reproduction section 14 to be output on the display section 12 as a reproducible video signal. The display section 12 displays a video image corresponding to the video signal on a screen. Similarly, the content data stored in the storage section 18 is managed and read by the file management section 17 or the like and decoded and analyzed in the codec section and the ECMA script analyzing section in the video reproduction section 14 to be output to and displayed in the display section 12 as a reproducible video signal.

Version Upgrade Processing

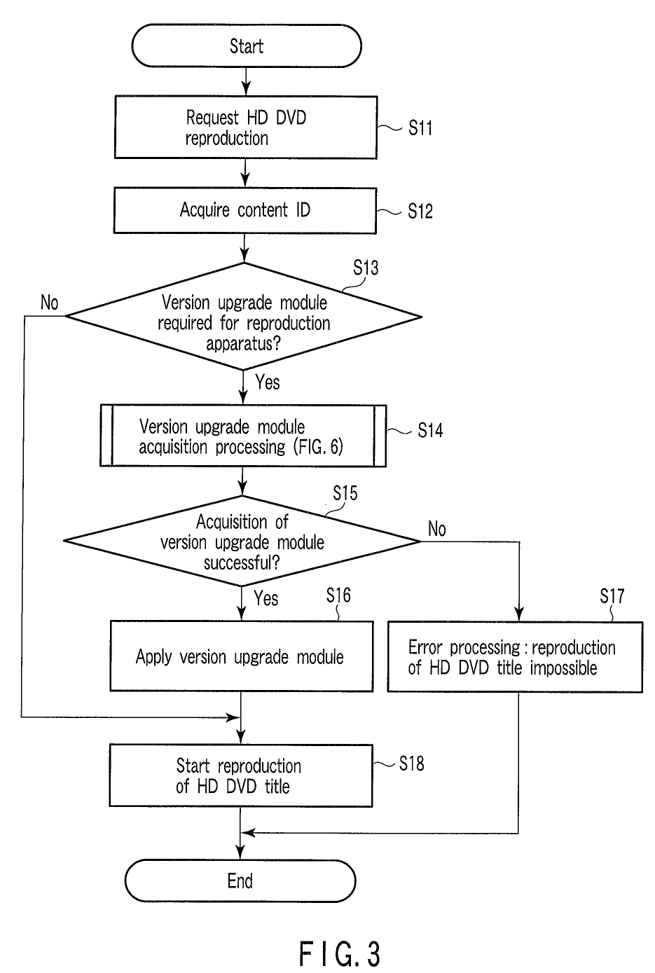

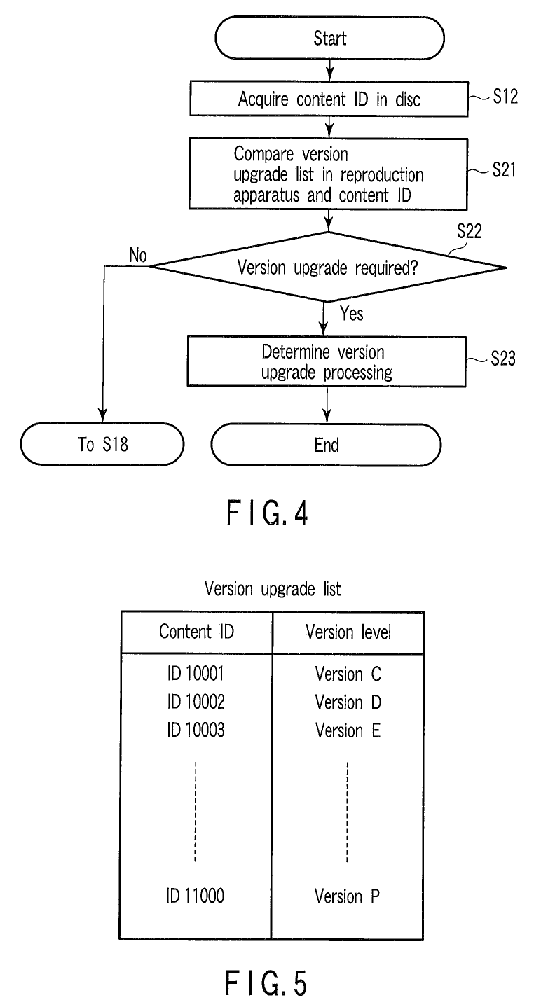

Next, an operation of version upgrade processing in the video reproduction section 14 based upon a content ID of an HD DVD video inherent to the embodiment or the like will be explained in detail below with reference to flowcharts. FIG. 3 is a flowchart showing one example of a version upgrade operation of a reproduction module 14m of a reproduction apparatus according to one embodiment of the present invention. FIG. 4 is a flowchart showing one example of determining whether or not version upgrade of the reproduction apparatus according to one embodiment of the present invention is required. FIG. 5 is a diagram showing one example of a version upgrade list handled by the reproduction apparatus according to one embodiment of the present invention.

Incidentally, each step in the flowcharts shown in FIGS. 3, 4, and 6 to 10 may be replaced by a circuit block and therefore respective steps in each flowchart can be all redefined by blocks.

When an HD DVD title produced before revised or an HD DVD title having a new function after revised according to influence of revision of HD DVD Video Standards or the like are reproduced, it is necessary to confirm information on a version upgrade site to perform version upgrade processing of the reproduction module.

That is, as shown by a flowchart in FIG. 3, when a user loads an optical disc D in the disc drive 13 or when a user conducts an operation such as pressing a reproduction button for reproducing simultaneously with loading of the optical disc D (Step S11), the control section 11 and the disc management section 15 read information from the optical disc D to extract a content ID (or a disc ID, a plurality of content IDs or the like) from the information (Step S12). This step is also shown as Step (1) in FIG. 2.

The version upgrade management section 16 determines whether or not version upgrade is required based upon the content ID or the like (Step S13), as described later referring to the flowchart shown in FIG. 4. This step is also shown as Step (2) in FIG. 2.

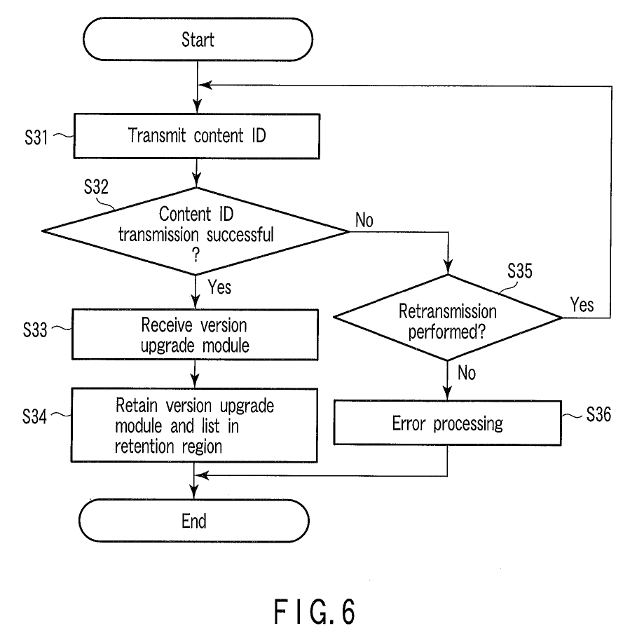

When the version upgrade management section 16 determines that the version upgrading is required, acquisition processing of a version upgrade module is performed by the control section 11 and the version upgrade management section 16 according to a procedure shown by the flowchart in FIG. 6 (Step S14).

Here, the control section 11 and the version upgrade management section 16 determine that the version upgrade module has been acquired successfully (Step S15), as shown in Step (7) in FIG. 2, they apply the version upgrade module to the video reproduction section 14 (Step S16). That is, the reproduction module 14m is updated to the acquired version upgrade module or the version upgrade module is added to the reproduction module 14m. Reproduction of the HD DVD title or the like is started (Step S18).

Here, the reproduction module 14m includes the codec section and the ECMS script analyzing section as one specific example. That is, as the codec, VC-1, MPEG2, H.264, or the like is prepared, and another kind of codec is supplied as the version upgrade module, as necessary.

Similarly, regarding an API function performed by an analyzing function of the ECMA script, a new API function is added in addition to the API function currently provided as a version upgrade module, as necessary.

When the control section 11 and the version upgrade management section 16 determine failure in acquisition of the version upgrade module (Step S15), error processing is performed and reproduction processing of the HD DVD title or the like is not performed (Step S17).

Incidentally, when it is determined in Step S13 that it is unnecessary to conduct version upgrade, the HD DVD title is started to be reproduced using the reproduction module in the current version or after version upgrade of the video reproduction section 14 has been conducted by a reproduction module of a version incorporated in the storage section 18 (Step S18).

That is, when the version upgrade management section 16 determines that it is unnecessary to conduct version upgrading, a plurality of codecs and a plurality of API functions are provided in the storage section 18 and the video reproduction section 14 in the reproduction apparatus 10 in advance, so that they can be selectively used to conduct reproduction as appropriate depending on the content ID.

Determining Version Upgrade

Next, version upgrade processing will be explained referring to a flowchart shown in FIG. 4. That is, the control section 11 and the version upgrade management section 16 detect and acquire a content ID (or a disc ID, a plurality of content IDs or the like) in the disc (Step S12). Next, the control section 11 and the version upgrade management section 16 acquire a version upgrade list such as shown in FIG. 5 from the storage section 18 or the like and they compare a version level corresponding to the detected content ID and a current version level of the video reproduction section 14 stored in the version upgrade management section 16 with each other (Step S21). When the version level corresponding to the detected content ID is higher than the current version level, the control section 11 and the version upgrade management section 16 determines that it is necessary to conduct version upgrade (Step S22).

Version Upgrade Module Acquisition Processing

Next, version upgrade module acquisition processing in Step S14 will be explained by referring to a flowchart shown in FIG. 6. FIG. 6 includes transmission processing of a content ID of the reproduction apparatus and reception processing of a version upgrade list and a version upgrade module.

In Step S13 in FIG. 3, when the control section 11 and the version upgrade management section 16 determine that it is necessary to conduct version upgrade module, they transmit the acquired content ID (or a disc ID, a plurality of content IDs or the like) to the communication section 31 in the database server DS via the communication section 19, as shown in Step S31 in FIG. 6 and Step (3) in FIG. 2.

The control section 11 and the version upgrade management section 16 fail in transmission of the content ID, they repeat transmission of the content ID when retransmission has been set (Step S35). Error processing is performed (Step S36) when retransmission has not been set (Step S35).

When the control section 11 and the version upgrade management section 16 have succeeded in transmission of the content ID, they receive a version upgrade module and a version upgrade list from the communication section 31 of the database server DS via the communication section 19, as shown in Step (5) in FIG. 2 and Step S33. As shown in Step (6) in FIG. 2 and Step S34, the control section 11 and the version upgrade management section 16 retains the version upgrade module and the version upgrade list in a retention region such as the storage section 18 or the like as shown in Step (6) in FIG. 2 and Step S34.

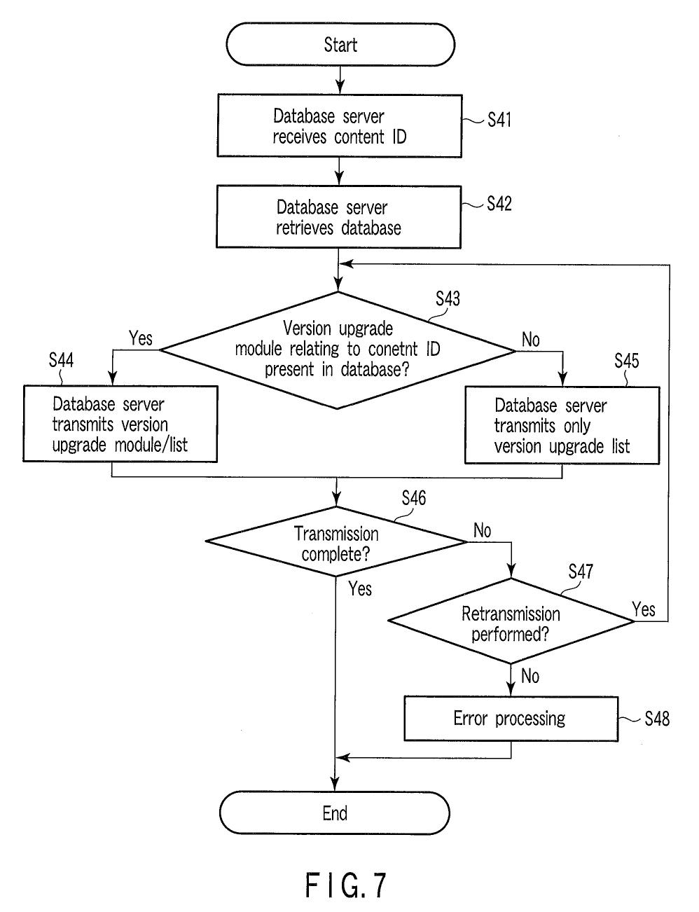

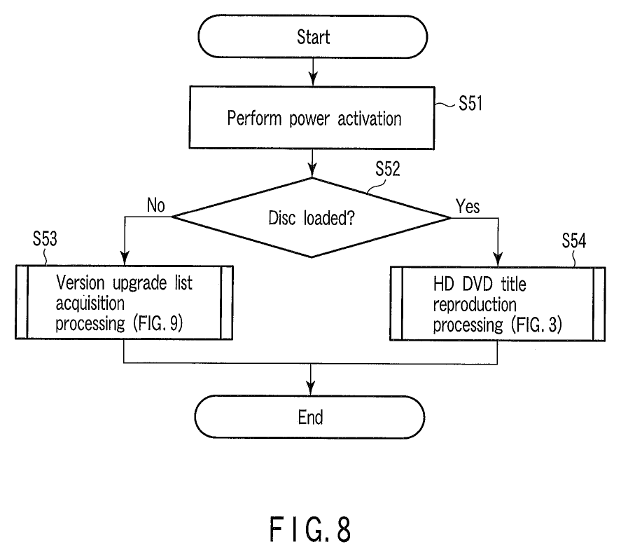

Next, processing on the database server DS side corresponding to the transmission processing in the reproduction apparatus 10 will be explained. FIG. 7 is a flowchart showing one example of transmission and reception processing of the database server DS conducting communication with the reproduction apparatus 10.

The database management section 32 in the database server DS receives the content ID or the like via the communication section 31 (Step S41). In Step (4) in FIG. 2, the database management section 32 retrieves a version update module and/or a version upgrade list from the database section 33 based upon the content ID (Step S42).

When the database management section 32 determines that a version upgrade module relating to the content ID is present (Step S43), it transmits the version upgrade module and the version upgrade list to the reproduction apparatus 10 via the communication section 31 (Step S44).

When the database management section 32 determines that the version upgrade module relating to the content ID is absent, it transmits only the version upgrade list to the reproduction apparatus 10 via the communication section 31 (Step S44).

The database management section 32 completes the processing according to completion of the transmission. However, when the transmission is not completed and retransmission has been set, the retransmission is performed (Step S47), but when there is no setting of retransmission, error processing is performed and the processing is terminated (Step S48).

Automatic Acquisition Processing of Version Upgrade List

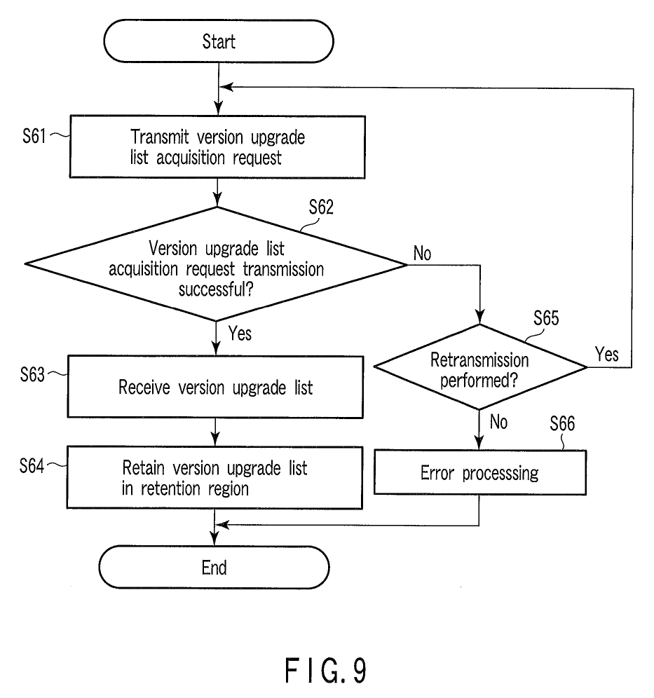

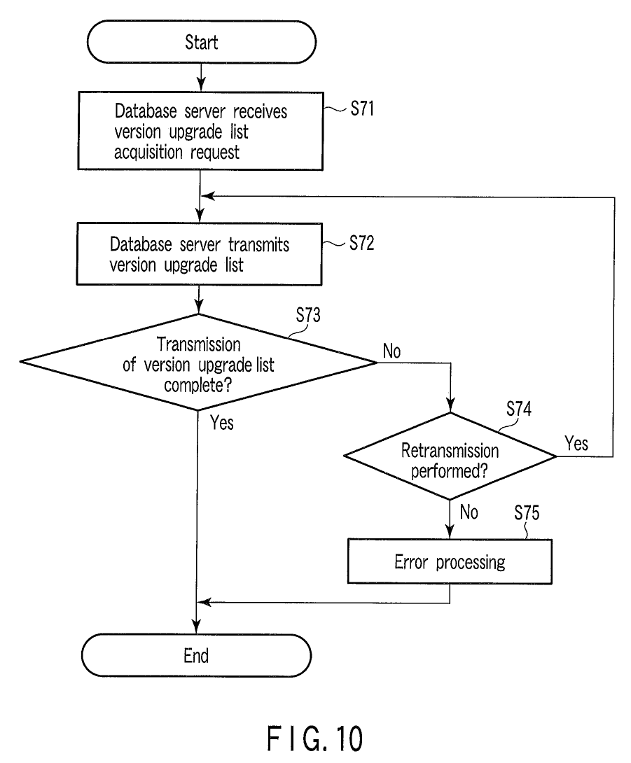

Next, automatic acquisition processing of a version upgrade list in the reproduction apparatus 10 will be explained below with reference to the drawings. FIG. 8 is a flowchart showing one example of automatic reception processing of a version upgrade list of the reproduction apparatus. FIG. 9 is a flowchart showing one example of automatic transmission processing for a version upgrade list of the reproduction apparatus. FIG. 10 is a flowchart showing one example of automatic transmission processing for a version upgrade list of the database server conducting communication with the reproduction apparatus.

That is, it is preferable that the reproduction apparatus 10 automatically acquires a version upgrade list, for example, at an actuation time or the like. In the flowchart shown in FIG. 8, when power activation is performed in the reproduction apparatus 10 (Step S51), reproduction processing of an HD DVD title previously shown regarding FIGS. 3 to 7 is performed in a loaded state of a disc into the disc drive 13 in the reproduction apparatus 10 and a version upgrade list is acquired (Step S54). However, when a disc has not been loaded in the disc drive 13 in Step S52, a version upgrade list is acquired in the following manner (Step S53).

That is, the control section 11 and the version upgrade management section 16 in the reproduction apparatus 10 transmit a version upgrade acquisition request signal to the database server DS on a network via the communication section 19 (Step S61). The control section 11 and the version upgrade management section 16 in the reproduction apparatus 10 determine that transmission of the version upgrade list acquisition request signal has ended in failure (Step S62), and they repeat transmission when the transmission has been set (Step S65). Unless the transmission has been set, error processing is performed (Step S66).

When the control section 11 and the version upgrade management section 16 in the reproduction apparatus 10 determines that transmission of the version upgrade list acquisition request signal has been performed successfully, they receive a version upgrade list from the database server DS (Step S63) and retain the version upgrade list in the storage section 18 which is a retention region (Step S64) as Step (6) in FIG. 2.

On the other hand, the database management section 32 in the database server DS on Internet receives the version upgrade list request signal via the communication section 31 (Step S71), as shown by the flowchart in FIG. 10. The database management section 32 in the database server DS transmits a version upgrade list detected from the database section 33 to the reproduction apparatus 10 via the communication section 31 (Step S72) as Step (5) in FIG. 2.

Here, when the database management section 32 determines that transmission of the version upgrade list has been completed, the processing is terminated (Step S73). However, when the database management section 32 determines that transmission of the version upgrade list has not been completed and transmission has been set (Step S74), the database management section 32 repeats transmission. Unless the transmission has been set, the database management section 32 performs error processing (Step S75). Thereby, the version upgrade list is transmitted to the producing apparatus 10 from the database server DS via Internet.

As described above, according to the reproduction system comprising the reproduction apparatus 10 and the database server DS according to one embodiment of the present invention, a necessary reproduction module is automatically updated at a timing where a content ID or the like has been detected by simply loading an optical disc such as an HD DVD without a user's special operation. Accordingly, reliable reproduction processing can be performed using the latest reproduction module corresponding to content to be reproduced without requiring a user's special operation.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A reproduction apparatus comprising:
an optical disc drive which reads identification information of content recorded on an optical disc;
a communication section which conducts communication with an external apparatus via a network;
a reproduction section which reproduces content using a reproduction module;
a determination section which determines whether or not update of the reproduction module in the reproduction section is required based upon comparison between the identification information and a version upgrade list of content;
an acquisition section which acquires another reproduction module from the external apparatus via the communication section when the update of the reproduction module is required; and
an update section which updates the reproduction module using another reproduction module acquired by the acquisition section, wherein
the reproduction section reproduces the content recorded on the optical disc using the reproduction module updated by the update section.

2. The reproduction apparatus according to claim 1, wherein
the acquisition section supplies the identification information to the external apparatus via the communication section and receives the version upgrade list from the external apparatus.

3. The reproduction apparatus according to claim 1, wherein
the version upgrade list includes at least a plurality of the identification information and values showing levels of version upgrade corresponding to the plurality of the identification information.

4. The reproduction apparatus according to claim 3, wherein
the determination section determines a level of a version upgrade corresponding to the identification information read by the optical disc drive from a plurality of version upgrade levels respectively corresponding to a plurality of the identification information in the version upgrade list and compares the determined level and the level of the version of the reproduction module in the reproduction section to determine whether or not update is required.

5. The reproduction apparatus according to claim 1, wherein
the update section automatically updates the version upgrade list from the external apparatus via the communication section when power activation is performed.

6. A reproduction system where an optical disc reproduction apparatus and a database server apparatus are connected to each other via a network, wherein the reproduction apparatus comprises:
an optical disc drive which reads identification information of content recorded on an optical disc;
a first communication section which conducts communication with the server apparatus via a network;
a reproduction section which reproduces content using a reproduction module;
a determination section which determines whether or not update of the reproduction module in the reproduction section is required based upon a comparison between the identification information and a version upgrade list of content;
an acquisition section which acquires another reproduction module from the server apparatus via the communication section when the update of the reproduction module is required; and
an update section which updates the reproduction module using another reproduction module acquired by the acquisition section, wherein
the reproduction section reproduces the content recorded on the optical disc using the reproduction module updated by the update section;
the server apparatus comprises:
a second communication section which conducts communication with the communication section in the reproduction apparatus via a network;
a database section which stores a reproduction module for content and a version upgrade list; and
a database management section which, when receives the identification information from the reproduction apparatus via the second communication section, reads a reproduction module and a version upgrade list corresponding to the identification information from the database section to supply them to the reproduction apparatus.

7. The reproduction system according to claim 6, wherein
when the database has a reproduction module corresponding to the identification information, the database management section supplies the corresponding reproduction module and the version upgrade list to the reproduction apparatus, and when the database does not have a reproduction module corresponding to the identification information, the database management section supplies only the version upgrade list to the reproduction apparatus.

8. A method for reproducing content recorded on an optical disc using a reproduction module in a reproduction section connected to a database server apparatus via a network, comprising:
reading identification information of content recorded on an optical disc;
determining whether or not update of the reproduction module is required based upon comparison between the identification information and a version upgrade list stored in a storage section;
acquiring another reproduction module from the server apparatus when update of the reproduction module is required;
updating the reproduction module in the reproduction section using another reproduction module; and
reproducing the content recorded on the optical disc using the updated reproduction module.

9. The reproduction method according to claim 8, wherein acquiring another reproduction module is performed by supplying the identification information to the server apparatus via the network and receiving another reproduction module corresponding to the identification information from the server apparatus.

10. The reproduction method according to claim 8, wherein the version upgrade list has at least a plurality of the identification information and values showing levels of version upgrade corresponding to the plurality of the identification information.
